(19) United States
(12) Patent Application Publication
(10) Pub. No.: US 2024/0307258 A1
(43) Pub. Date: Sep. 19, 2024

(54) Interactive Sex Toy Systems with Optional Virtual Reality Integration

(71) Applicant: Stanislav Kulyk, Lublin (PL)

(72) Inventor: Stanislav Kulyk, Lublin (PL)

(21) Appl. No.: 18/184,027

(22) Filed: Mar. 15, 2023

(51) Int. Cl. A61H 19/00; A61H 23/02; G06F 3/01

(52) U.S. Cl. CPC A61H 19/44; A61H 19/32; A61H 23/02; G06F 3/011; A61H 2201/0119; A61H 2201/0188; A61H 2201/5007; A61H 2201/5043; A61H 2201/5058; A61H 2201/5092; A61H 2201/5097

(57) ABSTRACT

Provided herein is an interactive sex toy and sex toy system with optional virtual reality integration. A first embodiment comprises a phallic shaped housing having a plurality of first sensors proximately located to the housing's external surface. A second embodiment further comprises a docking pad having a plurality of second sensors proximately located on the docking pad's top surface. The various embodiments can be communicatively coupled with a second device and/or one or more virtual reality systems to facilitate real-time or near real-time sexual acts between a first user utilizing the interactive sex toy and/or a virtual reality system and a second user utilizing the second device and/or a virtual reality system. An application running on a first user device and/or on a second user device can facilitate communication between the aforementioned components.

### TECHNICAL FIELD

The present disclosure generally relates to sex toys. Specifically, the present disclosure relates to sex toys and sex toy systems having sensory detection compatible with virtual reality systems.

### BRIEF SUMMARY OF THE INVENTION

Disclosed herein is an interactive sex toy comprising a phallic shaped housing enclosing a computer having a processor, a first plurality of sensors proximately located to the external surface of the housing, and a power source located within the housing and coupled to the computer and the first plurality of sensors. A first plurality of data is obtained by at least one sensor from the first plurality of sensors when the interactive sex toy is used by a first user. The processor and the first plurality of sensors are communicatively coupled and configured to perform the communicative coupling of the interactive sex toy with a second device and transmitting the first plurality of data to the second device. In some embodiments, the housing is waterproof.

In some embodiments the power source is a rechargeable battery.

In some embodiments the interactive sex toy further comprises a docking pad configured to selectively receive the housing in a substantially upright position.

In some embodiments where the power source is a rechargeable battery, the docking pad is configured to use an external power source to recharge the power source when the housing is received by the docking pad.

In some embodiments the interactive sex toy further comprises a second plurality of sensors on the upper surface of the docking pad. The second plurality of sensors are configured to obtain a second plurality of sensory data. The second plurality of sensors are communicatively coupled with the computer and configured to, in conjunction with the processor, transmit the second plurality of sensory data to the second device.

In some embodiments, the housing and the docking pad further comprise at least one LED indicator light configured to convey a plurality of information to the first user.

In some embodiments, the sensors from the first plurality of sensors and the second plurality of sensors are selected from the group of an ultrasonic sensor, a laser sensor, an infrared sensor, a capacitive sensor, and combinations thereof. Furthermore, the first plurality of sensory data and the second plurality of sensory data include data selected from the group of ultrasonic sensor data, laser sensor data, infrared sensor data, tactile data, and combinations thereof.

In some embodiments, the second device is a male sex toy such as a penis sleeve or a female sex toy such as a vibrator configured to reactively provide tactile sensations to a second user in response to the first user's interaction with the interactive sex toy in real-time or in near real-time. In such embodiments, the processor is further configured to communicatively couple (“pair”) the interactive sex toy with a virtual reality device and to transmit the first and second plurality of sensory data to the virtual reality device in real-time or near real-time when the interactive sex toy is engaged. When the interactive sex toy is used in conjunction with the second device and the virtual reality device, the virtual reality device may use the received first and/or second plurality of data to display simulated interaction based on the first user's interaction with the interactive sex toy in real-time or in near real-time.

In some embodiments, the interactive sex toy further comprises an on/off switch on the external surface of the housing.

In some embodiments, the interactive sex toy is configured to selectively turn on and off based on the first user's interaction with the first plurality of sensors.

### BRIEF DESCRIPTION OF THE DRAWINGS

This invention will be better understood with reference to the following figures which are intended to illustrate specific embodiments within the overall scope of the invention as claimed:

FIG. 1 is perspective view of an interactive sex toy according to an embodiment of the present invention;

FIG. 2 is a perspective view of an exemplary usage of the interactive sex toy of FIG. 1;

FIG. 3 is a flow chart illustrating a method of using the interactive sex toy of FIG. 1; and,

FIG. 4 is a diagram of an example environment in which systems described herein may be implemented.

### DETAILED DESCRIPTION OF THE INVENTION

In the following description, to better understand the aforementioned purposes, features, and advantages of the present invention, numerous specific details are set forth in order to provide a thorough understanding of the subject matter. It should be noted that these details and examples are provided to merely aid in understanding the descriptions, and they do not, in any way, limit the scope of the present invention. The present invention can also be implemented in other modes different from those described herein and the present invention is not limited to the specific embodiments disclosed below.

It will be appreciated that numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way, but rather as merely describing implementation of the various embodiments described herein.

Embodiments described herein provide for interactive sex toys utilizing a plurality of sensors. Preferably, the disclosed embodiments are utilized in conjunction with a second device such as a reactive male or female sex toy and/or a virtual reality device such as a virtual reality headset. Some embodiments disclosed herein utilize a virtual reality system having a memory and a processor configured to receive and store a plurality of data, to process the plurality of data to generate visual graphics, and to display the generated visual graphics to a user. Although the second device is described herein as an interactive sex toy or the like, in practice the second device can be any device.

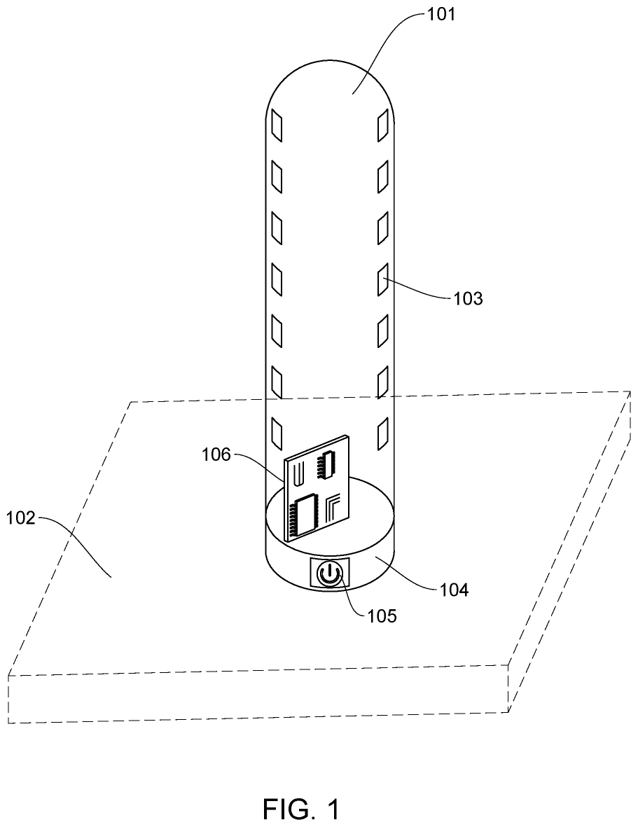

FIG. 1 is perspective view of an interactive sex toy according to a first embodiment of the present invention comprising a phallic shaped housing 101, a first plurality of sensors 103 proximately located to the external surface of the housing, a computer having a processor 106, a power source 104 and a docking pad 102. The first plurality of sensors 103 are communicatively coupled to the computer 106 are configured to obtain a first plurality of sensory data from a first user during use of the interactive sex toy. In some embodiments, the housing further comprises a vibrating motor coupled to the power source and the processor.

The processor and the first plurality of sensors 103 are configured to communicatively couple the interactive sex toy with a second device and to transmit the first plurality of sensory data to the second device.

The docking pad 102 is configured to selectively receive the housing 101 in a substantially upright position.

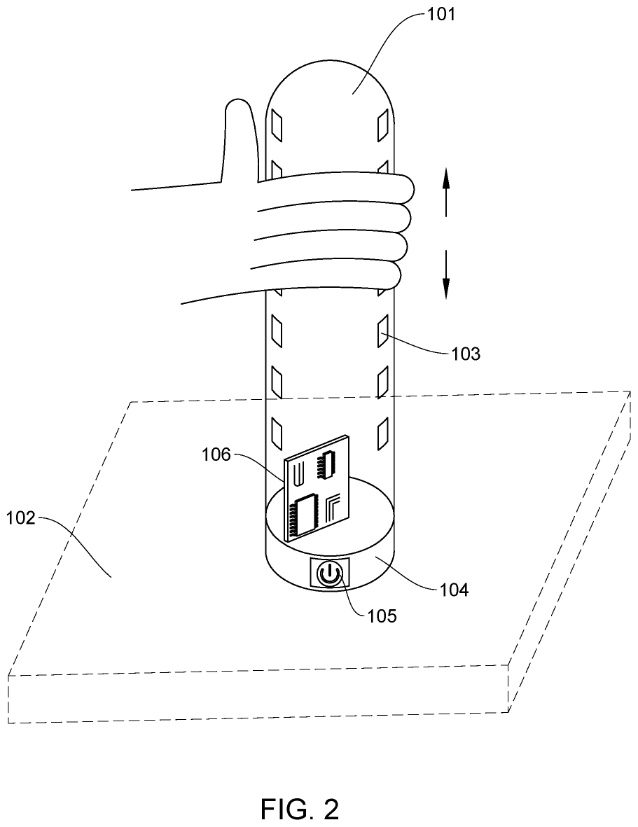

FIG. 2 is a perspective view of an exemplary usage of the interactive sex toy of FIG. 1 where a first user's hand manually masturbates the housing 101. As the user's hand traverses along the vertical axis, various sensors from the first plurality of sensors 103 obtain a first plurality of sensory data corresponding to the interaction of the hand with the housing 101. Although only up and down motion along a vertical axis is shown, in practice, a wide variety of hand movements and other bodily actions can be used to engage the housing to generate a first plurality sensory data.

Although only manual hand stimulation is illustrated, the housing is configured for insertion into vaginas, anuses, and other body cavities.

The sensors from the first plurality of sensors 103 are selected from the group an ultrasonic sensor, a laser sensor, an infrared sensor, a capacitive sensor, and combinations thereof.

The first sensory data includes data selected from the group of data selected from the group of ultrasonic sensor data, laser sensor data, infrared sensor data, tactile data, and combinations thereof.

In some embodiments the power source is a rechargeable battery.

In some embodiments the interactive sex toy further comprises a docking pad configured to selectively receive the housing in a substantially upright position.

In some embodiments where the power source is a rechargeable battery, the docking pad 102 is configured to use an external power source to recharge the power source 104 when the housing 101 is received by the docking pad 102.

In some embodiments the interactive sex toy further comprises a second plurality of sensors (not shown) proximately located to the upper surface of the docking pad 102. In some embodiments, the second plurality of sensors are located within the docking pad and their measurement part is flush to the upper surface of the docking pad. In other embodiments, the second plurality of sensors are located on the upper surface of the docking pad such that the upper surface of the docking pad is not substantially flat. The second plurality of sensors are configured to obtain a second plurality of sensory data when the docking pad is engaged by the first user. The second plurality of sensors are communicatively coupled with the computer and configured to, in conjunction with the processor, transmit the second plurality of sensory data to the second device.

In some embodiments, the housing further comprises at least one LED indicator light communicatively coupled to the processor and configured to convey a plurality of information to the first user. In such embodiments, the at least one LED indicator lights are proximately located to the exterior surface of the housing such that they are readily perceivable by the first user. In some embodiments, the docking pad further comprises at least one LED indicator light configured to convey a plurality of information to the first user. In such embodiments, the at least one LED indicator lights are proximately located to the exterior surface of the docking pad such that they are readily perceivable by the first user.

Similarly to the first plurality of sensors 103, the sensors from the second plurality of sensors are selected from the group an ultrasonic sensor, a laser sensor, an infrared sensor, a capacitive sensor, and combinations thereof.

Likewise, the second plurality of sensory data includes data selected from the group of data selected from the group of ultrasonic sensor data, laser sensor data, infrared sensor data, tactile data, and combinations thereof.

In some embodiments, the second device is a male sex toy such as a penis sleeve or a female sex toy such as a vibrator configured to reactively provide tactile sensations to a second user in response to the first user's interaction with the interactive sex toy in real-time or in near real-time. In such embodiments, the processor is further configured to communicatively couple (“pair”) the interactive sex toy with a virtual reality device and to transmit the first and second plurality of sensory data to the virtual reality device in real-time or near real-time when the interactive sex toy is engaged. When the interactive sex toy is used in conjunction with the second device and the virtual reality device, the virtual reality device is configured to process the received first and/or second plurality of data in order to generate and display simulated interaction based on the first user's interaction with the interactive sex toy in real-time or in near real-time.

In some embodiments, the computer is configured to be selectively communicatively coupled with a user device such a smart phone. An application stored within the memory of the user device and executed by the one or more processors of the user device can be used to facilitate such a pairing.

In some embodiments, the interactive sex toy further comprises an on/off switch on the external surface of the housing.

In some embodiments, the interactive sex toy is configured to selectively turn on and off based on a user's interaction with the first plurality of sensors.

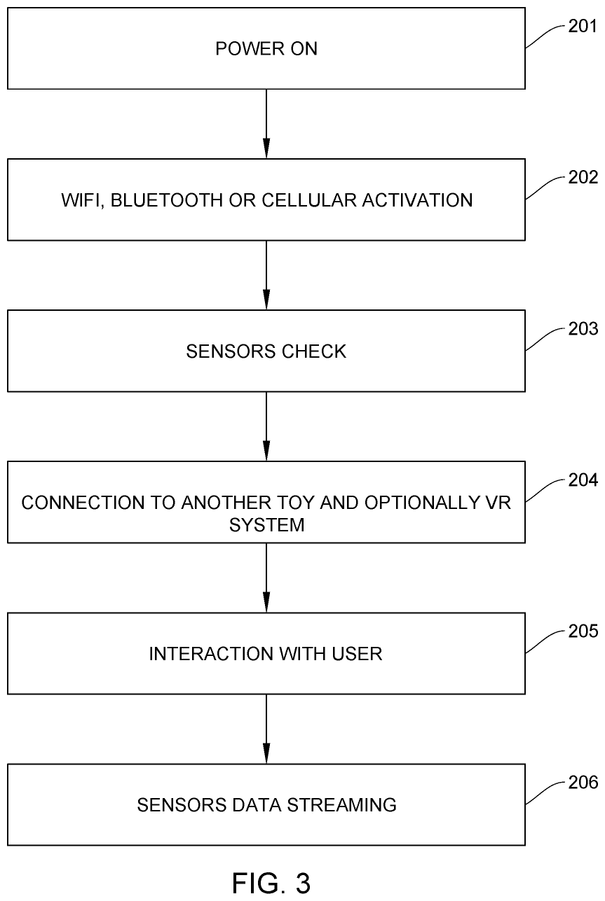

FIG. 3 is a flow chart illustrating a method of using the interactive sex toy of FIG. 1. At step 201, the user powers on the interactive sex toy by engaging the on/off button and/or by engaging the first plurality of sensors. At step 202, the computer 106 performs WI-FI, Bluetooth® or cellular modem component activation that allows the user to establish a communicative connection between the computer 106 and an application stored on a user device. After this optional pairing, at step 203, the interactive sex toy performs a sensor check to determine the operability of the sensors from the first plurality of sensors. If any sensor is found to be operably defective, the user is notified of the one or more defective sensors and their location via the user device. If there are no operably defective sensors, then, at step 204, the computer communicatively couples to a second device and/or a virtual reality device. In some embodiments, the application facilitates the communicative connection between the interactive sex toy, the second device, and/or the virtual reality device. In other embodiments, two user devices each running an application separately may be communicatively coupled so that the various components of a system can interact with one another and transmit data to one another.

At step 205, the user interacts with the interactive sex toy resulting in a first and/or second plurality of sensory data to be streamed to communicatively coupled devices 206. Preferably, when the interactive sex toy is used in conjunction with the second device and the virtual reality device, the virtual reality device may use the received first and/or second plurality of data to display simulated interaction based on the first user's interaction with the interactive sex toy in real-time or in near real-time. Furthermore, the second device may be configured to react to a user's interaction with the interactive sex toy in real-time or in near real-time.

For illustrative purposes only, and without limitation, the second device may be a reactive penis sleeve used by a second user and configured to replicated the sensations captured by the first plurality of sensors in real-time or in near real-time as illustrated in FIG. 2. Continuing the example, the virtual reality device may be a virtual reality helmet used by the second user that generates and displays visual graphics corresponding to the manual hand stimulation of FIG. 2 based on the first and/or second plurality of data obtained during the manual hand stimulation.

In some embodiments the computer is further configured to determine whether the received sensory data corresponds to actions that exceed the physical limitations of the second device, and, in response to determining that the physical limitations of the second device have been exceeded, to alert the user of the interactive sex toy of such a determination. The user can be alerted by an application notification, an embedded indication light on the docking pad, via vibration of the motor in the housing, or via an at least one LED indicator light on the housing and/or the docking pad.

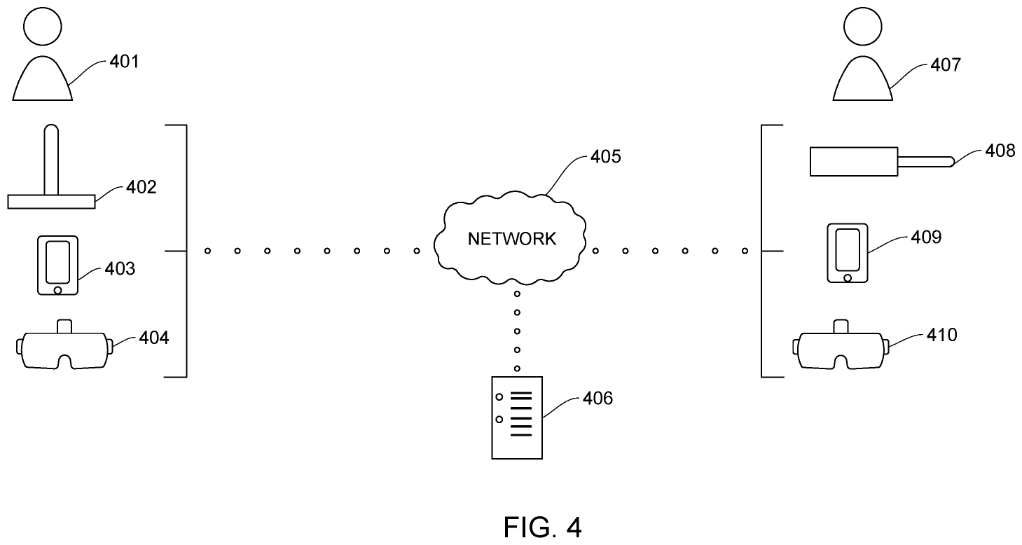

FIG. 4 is a diagram of an example environment in which systems described herein may be implemented comprising a first user 401, an interactive sex toy 402, a first user device 403, a first VR system 404, a second user 407, a second device 408, a second user device 409, a second VR system 410, and a web/cloud server 406, each communicatively coupled with one another through the network 405. The first user device 403 and the second user device 409 each run an application operating with the that facilitates the communicative coupling of the aforementioned components. The web/cloud server 406 is configured to facilitate the operability of the applications. In practice, the aforementioned devices may interconnect via wired connections, wireless connections, or a combination of wired and wireless connections. In some possible implementations, computing devices of the aforementioned environment may interconnect with a cellular network (e.g., a long-term evolution (LTE) network, a code division multiple access (CDMA) network, a 3G network, a 4G network, a 5G network, another type of next generation network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, and/or the like, and/or a combination of these or other types of networks.

The number and arrangement of components shown in FIG. 1 and FIG. 4 are provided as an example. In practice, the systems disclosed herein may include additional components, fewer components, different components, or differently arranged components than those shown in FIG. 1 and FIG. 4. Additionally, or alternatively, a set of components (e.g., one or more components) of the systems disclosed herein may perform one or more functions described as being performed by another set of components of the systems.

Environments in which systems described herein may be implemented are not limited in the number of users that can participate. For example, a plurality of users each utilizing a secondary device and a VR system can simultaneously or near simultaneously experience the sensations generated by a first user in real-time or near real-time.

The foregoing disclosure provides illustration and description, but is not intended to be exhaustive or to limit the implementations to the precise form disclosed. Modifications and variations are possible in light of the above disclosure or may be acquired from practice of the implementations.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code-it being understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

What is claimed is:

1. An interactive sex toy comprising:
a phallic shaped housing enclosing a computer having a processor;
a first plurality of sensors located proximately to the external surface of the housing; and,
a power source located within the housing and coupled to the computer and the first plurality of sensors;
wherein the processor and the first plurality of sensors are communicatively coupled and configured to perform:
communicatively coupling the interactive sex toy with a second device; and,
transmitting a first plurality of sensory data to the second device wherein the first plurality of sensory data is obtained by at least one sensor from the first plurality of sensors as the interactive sex toy is used by a first user.

2. The interactive sex toy of claim 1, wherein the housing is waterproof.

3. The interactive sex toy of claim 2, further comprising a docking pad configured to selectively receive the housing in a substantially upright position.

4. The interactive sex toy of claim 3, wherein the power source is a rechargeable battery and the docking pad is configured to recharge the power source when the housing is received.

5. The interactive sex toy of claim 4, wherein the docking pad further comprises a second plurality of sensors proximately located on the upper surface of the docking pad, wherein the second plurality of sensors are communicatively coupled to the processor and configured to perform:
transmitting a second plurality of sensory data to the second device used by a second user wherein the second plurality of sensory data is obtained by at least one sensor from the second plurality of sensors.

6. The interactive sex toy of claim 5, wherein:
the sensors from the first plurality of sensors and the second plurality of sensors are selected from the group of an ultrasonic sensor, a laser sensor, an infrared sensor, a capacitive sensor, and combinations thereof, and,
the first plurality of sensory data and the second plurality of sensory data include data selected from the group of ultrasonic sensor data, laser sensor data, infrared sensor data, tactile data, and combinations thereof.

7. The interactive sex toy of claim 6, wherein the housing and the docking pad further comprise at least one LED indicator light communicatively coupled to the processor and configured to convey a plurality of information to the first user.

8. The interactive sex toy of claim 7, wherein the housing further comprises a vibrating motor coupled to the power source and the processor.

9. The interactive sex toy of claim 8, wherein the second device is a sex toy configured to reactively provide tactile sensation to the second user in response to the first user's interaction with the interactive sex toy in real-time or in near real-time.

10. The interactive sex toy of claim 9 wherein the processor is further configured to perform:
communicatively coupling the interactive sex toy with a virtual reality device; and, transmitting the first plurality of sensory data and the second plurality of sensory data to the virtual reality device;
wherein the virtual reality device displays simulated interaction based on the user's interaction with the interactive sex toy in real-time or in near real-time.

11. The interactive sex toy of claim 10, wherein the computer is further configured to determine whether the received sensory data corresponds to actions that exceed the physical limitations of the second device, and, in response to determining that the physical limitations of the second device have been exceeded, to alert the first user of the determination.

12. An interactive sex toy system comprising:
a second device; and,
an interactive sex toy comprising:
a phallic shaped waterproof housing enclosing a computer having a first processor;
a first plurality of sensors located proximately to the external surface of the housing; and,
a power source located within the housing and coupled to the computer and the first plurality of sensors;
wherein the first processor and the first plurality of sensors are communicatively coupled and configured to perform:
communicatively coupling the interactive sex toy with the second device; and,
transmitting a first plurality of sensory data to the second device;
wherein the first plurality of sensory data is obtained by at least one sensor from the first plurality of sensors as the interactive sex toy is used by a first user.

13. The interactive sex toy system of claim 12, further comprising a docking pad configured to selectively receive the housing in a substantially upright position wherein the power source is a rechargeable battery and the docking pad is configured to recharge the power source when the housing is received.

14. The interactive sex toy system of claim 13, wherein the docking pad further comprises a second plurality of sensors located proximately to the upper surface of the docking pad, wherein the second plurality of sensors are communicatively coupled to the first processor and configured to transmit a second plurality of sensory data to the second device wherein the second plurality of sensory data is obtained by at least one sensor from the second plurality of sensors;
wherein the sensors from the first plurality of sensors and the second plurality of sensors are selected from the group of an ultrasonic sensor, a laser sensor, an infrared sensor, a capacitive sensor, and combinations thereof, and,
wherein the first plurality of sensory data and the second plurality of sensory data include data selected from the group of ultrasonic sensor data, laser sensor data, infrared sensor data, tactile data, and combinations thereof.

15. The interactive sex toy system of claim 14, further comprising a virtual reality device system having a second processor configured to perform:
receiving, from the interactive sex toy, the first plurality of sensory data and the second plurality of sensory data;
generating simulated interaction based on the received first plurality of sensory data and the second plurality of sensory data in real-time or in near real-time; and,
displaying the generated simulated interaction to a second user; and,
wherein the first processor is further configured to perform:
communicatively coupling the interactive sex toy with the virtual reality device system;
wherein the second device is configured to react to a user's interaction with the interactive sex toy in real-time or in near real-time.

16. The interactive sex toy system of claim 15, further comprising a first user device having a processor and a memory and a second user device having a processor and a memory, wherein an application stored and executed on the first user device and the second user device is configured to facilitate the communicative coupling of the interactive sex toy system, the virtual reality device system, and the second device.

17. The interactive sex toy system of claim 16, wherein the computer is further configured to determine whether the received sensory data corresponds to actions that exceed the physical limitations of the second device, and, in response to determining that the physical limitations of the second device have been exceeded, to alert the first user of such a determination.

18. An interactive sex toy system comprising:
a first virtual reality system having a processor used by a first user;
a second virtual reality system having a processor used by a second user;
a second device used by the second user;
a first interactive sex toy used by the first user comprising:
a phallic shaped waterproof housing enclosing a first computer having a first processor;
a first plurality of sensors located proximately to the external surface of the housing; and,
a power source located within the housing and coupled to the first computer and the first plurality of sensors;
a docking pad configured to selectively receive the housing in a substantially upright position;
a second plurality of sensors located proximately to the upper surface of the docking pad;
wherein the first processor and the first plurality of sensors are communicatively coupled and configured to perform:
communicatively coupling the first interactive sex toy with the second device; and,
transmitting a first plurality of sensory data to the second device;
wherein the first plurality of sensory data is obtained by at least one sensor from the first plurality of sensors;
wherein the first processor and the second plurality of sensors are communicatively coupled and configured to perform:
transmitting a second plurality of sensory data to the second device;
wherein the second plurality of sensory data is obtained by at least one sensor from the second plurality of sensors;
wherein the sensors from the first plurality of sensors and the second plurality of sensors are selected from the group of an ultrasonic sensor, a laser sensor, an infrared sensor, a capacitive sensor, and combinations thereof, and,
wherein the first plurality of sensory data and the second plurality of sensory data include data selected from the group of ultrasonic sensor data, laser sensor data, infrared sensor data, tactile data, and
combinations thereof.
wherein the processor of the first virtual reality system is configured to perform:
receiving, from the first interactive sex toy, the first plurality of sensory data and the second plurality of sensory data;
generating simulated interaction based on the received first plurality of sensory data and the second plurality of sensory data in real-time or in near real-time; and,
displaying the generated simulated interaction;
wherein the processor of the second virtual reality system is configured to perform:
receiving, from the first interactive sex toy, the first plurality of sensory data and the second plurality of sensory data;
generating simulated interaction based on the received first plurality of sensory data and the second plurality of sensory data in real-time or in near real-time; and,
displaying the generated simulated interaction;
wherein the first interactive sex toy is configured to reactively provide tactile sensation to the first user in response to the first user's interaction with the interactive sex toy in real-time or in near real-time; and,
wherein the second device is configured to reactively provide tactile sensation to the second user in response to the first user's interaction with the interactive sex toy in real-time or in near real-time.

19. The interactive sex toy system of claim 18, further comprising a first user device having a processor and a memory and a second user device having a processor and a memory, wherein an application stored and executed on the first user device and the second user device is configured to facilitate the communicative coupling of the first interactive sex toy, the second device, the first virtual reality system, and the second virtual reality system.

20. The interactive sex toy system of claim 19, wherein the first processor is further configured to determine whether the received sensory data corresponds to actions that exceed the physical limitations of the second device, and, in response to determining that the physical limitations of the second device have been exceeded, to alert the first user of such a determination.
